(19) United States
(12) Patent Application Publication
(10) Pub. No.: US 2017/0203413 A1
(43) Pub. Date: Jul. 20, 2017

(54) Safety structure for pliers

(71) Applicant: Li-Tu WU, Taichung City (TW)

(72) Inventor: Li-Tu WU, Taichung City (TW)

(21) Appl. No.: 14/997,585

(22) Filed: Jan. 18, 2016

(51) Int. Cl. B25B 7/12; B25F 1/00

(52) U.S. Cl. CPC B25B 7/123; B25F 1/003

(57) ABSTRACT

A safety structure for pliers contains: a fixed clamp jaw, a movable clamp jaw, a first handle, a second handle, an actuation unit, and an adjustment screw. The fixed clamp jaw is disposed on the first handle, and the movable clamp jaw is rotatably connected with the fixed clamp jaw and the second handle. The actuation unit includes a spring mounted on the first handle and between two rotatable connecting portions of the movable clamp jaw, and the actuation unit also includes a driving post rotatably connected the second handle and inserted into the first handle. The actuation unit further includes a threaded post having an arcuate section and includes a pushing post rotatably joined with the second handle and forced by the arcuate section. The driving post has a push portion, and the adjustment screw is screwed into the second handle and abuts against the push portion.

### FIELD OF THE INVENTION

The present invention relates to a safety structure for pliers which is capable of fixing two clamp jaws firmly and adjusting the two clamp jaws and two handles based on using requirements.

### BACKGROUND OF THE INVENTION

Conventional piles are adapted to cut steel cables, to twist metal tubes, to fix iron wires and handles, to remove nails and iron bolts, and to clamp workpieces.

A conventional adjustment structure of piles is disclosed in TW Patent No. M449066 and contains a fixed clamp jaw, a first handle, a first fixing portion connected with the first handle, a movable clamp jaw. The movable clamp jaw is connected with a second handle relative to the first handle and includes a second fixing portion corresponding to the fixing portion and rotatably connecting with the second handle and the fixed clamp jaw. The second fixing portion is driven by the second handle and moves relative to the first fixing portion. The conventional adjustment structure further comprises a locking unit which includes a limiting member rotatably coupling with the second handle and extending toward the first handle; and an adjustment unit including a threaded post screwing with the first handle and abutting against the limiting member of the locking unit, an adjusting button connecting with the threaded post, wherein the adjusting button has a control portion joining with the threaded post, and the control portion has an external face defined by an upper rim and a lower rim spaced from the upper rim. The control portion also has a recess defined between the upper rim and the lower rim.

However, as releasing two clamping arms, a release post between the first handle and the second handle is pulled so that a driving post moves reversely, but the two clamping arms remove easily when the pliers drop on the ground. Furthermore, a distance between the first handle and the second handle and a distance between the fixed clamp jaw and the movable clamp cannot be adjusted exactly by the threaded post, so a small workpiece cannot be clamped firmly, after adjusting the distance between the first handle and the second handle and the distance between the fixed clamp jaw and the movable clamp.

The present invention has arisen to mitigate and/or obviate the afore-described disadvantages.

### SUMMARY OF THE INVENTION

The primary objective of the present invention is to provide a safety structure for pliers which is capable of fixing two clamp jaws firmly and adjusting the two clamp jaws and two handles based on using requirements.

To obtain the above objective, a safety structure for pliers provided by the present invention contains: a fixed clamp jaw, a movable clamp jaw, a first handle, a second handle, an actuation unit, and an adjustment screw.

The fixed clamp jaw is disposed on one end of the first handle, one end of an inner surface of the movable clamp jaw is rotatably connected with an inner surface of the fixed clamp jaw, and one end of an outer surface of the movable clamp jaw is rotatably coupled with the second handle, between the first handle and the second handle is defined a hollow space.

The actuation unit includes a spring, a driving post, a threaded post, and a pushing post, wherein a first end of the spring is mounted on an inner surface of the first handle, and a second end of the spring is fixed between two rotatable connecting portions of the movable clamp jaw, a first end of the driving post is rotatably connected with an inner surface of the second handle, and a second end of the driving post is inserted into the inner surface of the first handle, the driving post has an arcuate section formed on an outer surface thereof and is locked on an edge of the first handle, and an edge of the threaded post abuts against the second end of the driving post, the pushing post is rotatably joined with the inner surface of the second handle and its one end corresponds to and is forced by the arcuate section, the driving post has a push portion formed on the first end thereof, and the adjustment screw is screwed into an outer surface of the second handle and its first end abuts against the push portion.

### BRIEF DESCRIPTION OF THE DRAWINGS

FIG. 1 is a perspective view showing the exploded components of a safety structure for pliers according to a preferred embodiment of the present invention.

FIG. 2 is a perspective view showing the assembly of the safety structure for the pliers according to the preferred embodiment of the present invention.

FIG. 3 is a side plan view showing the operation of the safety structure for the pliers according to the preferred embodiment of the present invention.

FIG. 4 is a cross sectional view of a part of FIG. 3.

FIG. 5 is a cross sectional view showing the operation of the safety structure for the pliers according to the preferred embodiment of the present invention.

FIG. 6 is another cross sectional view showing the operation of the safety structure for the pliers according to the preferred embodiment of the present invention.

### DETAILED DESCRIPTION OF THE PREFERRED EMBODIMENTS

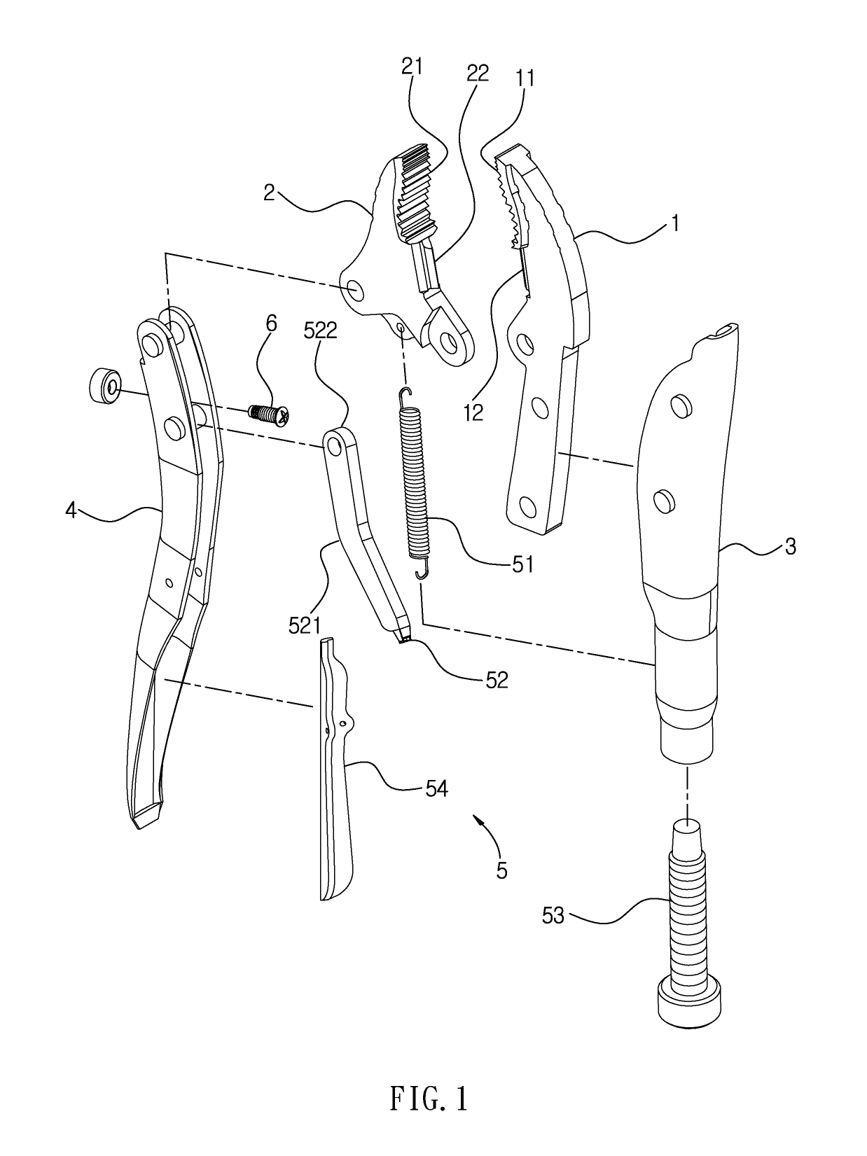

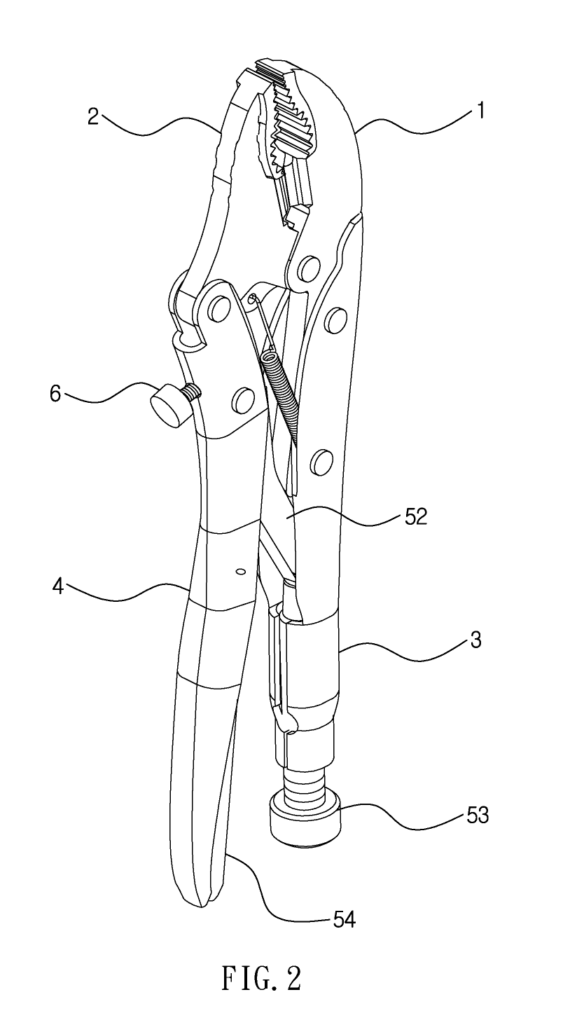

With reference to FIGS. 1 to 6, a safety structure for pliers according to a preferred embodiment of the present invention is capable of fixing two clamp jaws firmly and adjusting the two clamp jaws and two handles based on using requirements. The safety structure comprises a fixed clamp jaw 1, a movable clamp jaw 2, a first handle 3, a second handle 4, an actuation unit 5, and an adjustment screw 6.

The fixed clamp jaw 1 is disposed on one end of the first handle 3, one end of an inner surface of the movable clamp jaw 2 is rotatably connected with an inner surface of the fixed clamp jaw 1, and one end of an outer surface of the movable clamp jaw 2 is rotatably coupled with the second handle 4. Between the first handle 3 and the second handle 4 is defined a hollow space. The actuation unit 5 includes a spring 51, a driving post 52, a threaded post 53, and a pushing post 54, wherein a first end of the spring 51 is mounted on an inner surface of the first handle 3, and a second end of the spring 51 is fixed between two rotatable connecting portions of the movable clamp jaw 2. A first end of the driving post 52 is rotatably connected with an inner surface of the second handle 4, and a second end of the driving post 52 is inserted into the inner surface of the first handle 3. The driving post 52 has an arcuate section 521 formed on an outer surface thereof and is locked on an edge of the first handle 3, and an edge of the threaded post 53 abuts against the second end of the driving post 52. The pushing post 54 is rotatably joined with the inner surface of the second handle 4 and its one end corresponds to and is forced by the arcuate section 521. The driving post 52 has a push portion 522 formed on the first end thereof, and the adjustment screw 6 is screwed into an outer surface of the second handle 4 and its first end abuts against the push portion 522, wherein the adjustment screw 6 has a horizontal screwing section and a vertical screwing section configured to screw with the horizontal screwing section, a diameter of the horizontal screwing section is more than the vertical screwing section, such that the adjustment screw 6 is rotated to move on the second handle 4 fixedly.

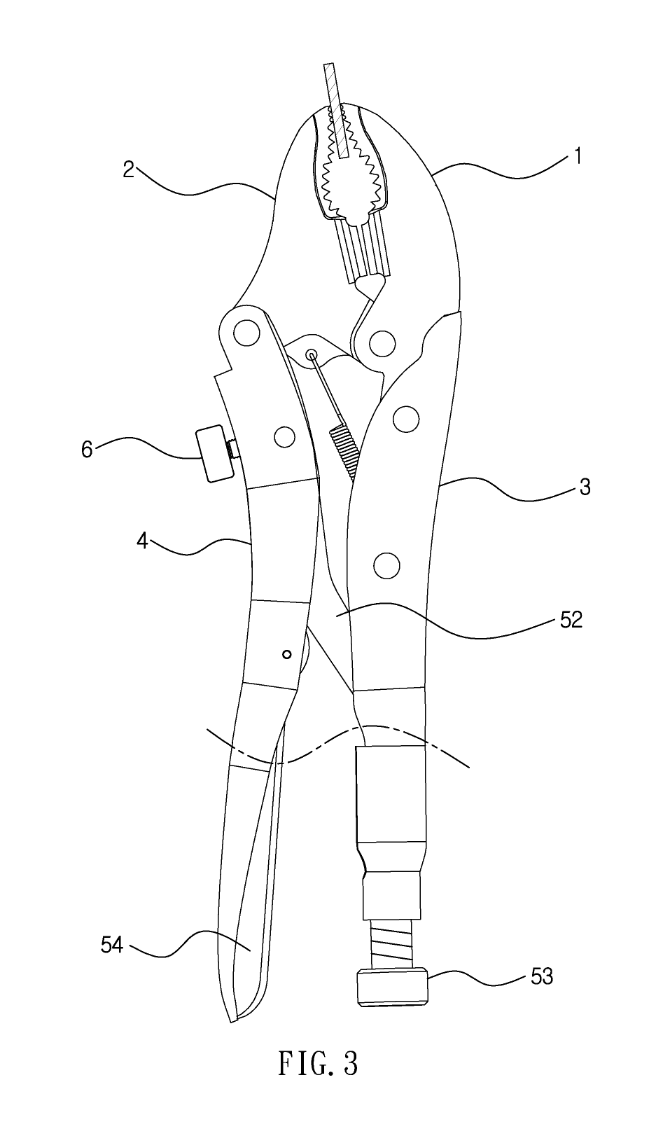

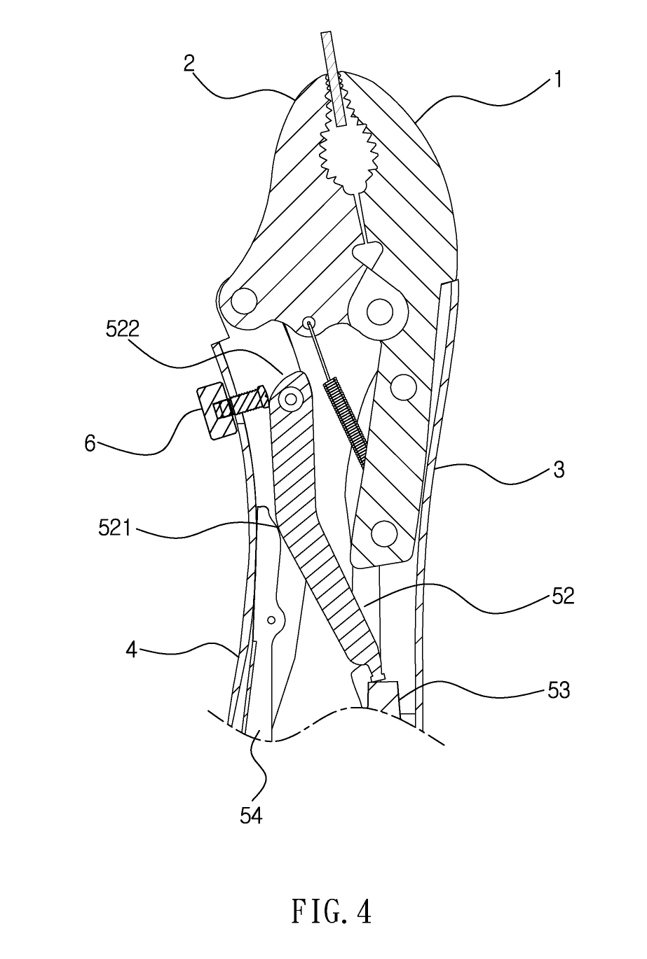

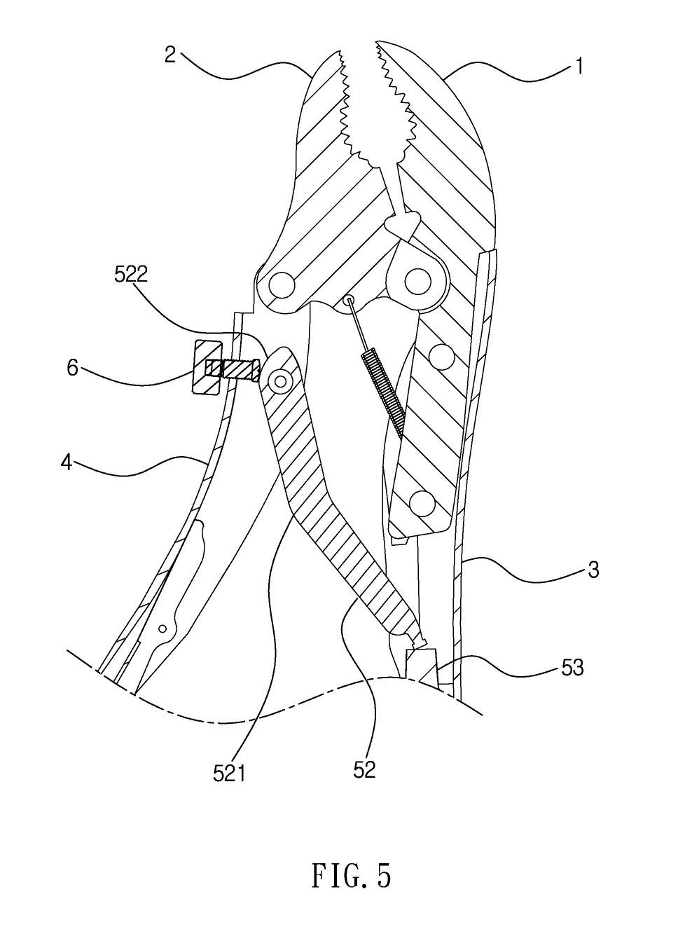

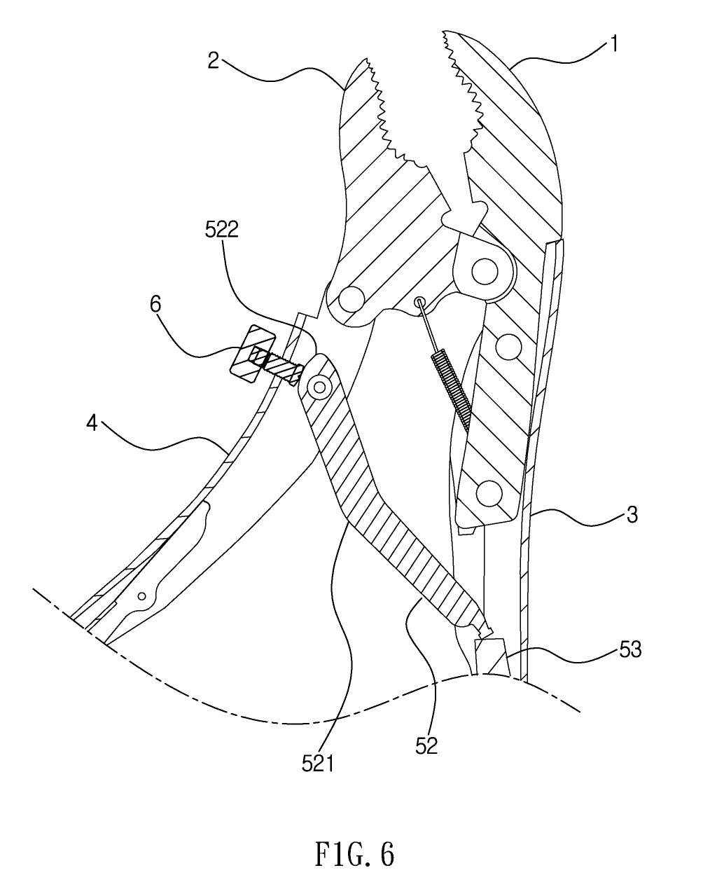

In operation, the actuation unit 5 controls a clamping distance between the fixed clamp jaw 1 and the movable clamp jaw 2, hence when the fixed clamp jaw 1 and the movable clamp jaw 2 clamp a workpiece, the fixed clamp jaw 1 forces the first handle 3, and the movable clamp jaw 2 presses the second handle 4, such that a rotatable connection portion of the driving post 52 and the second handle 4 offsets, and the one end of the pushing post 54 is forced by the arcuate section 521. Thereafter, the adjustment screw 6 is rotated to abut against the push portion 522 of the driving post 52, and the pushing post 54 is limited by the arcuate section 521 and does not push the driving post 52, thus fixing the fixed clamp jaw 1 and the movable clamp jaw 2, as shown in FIGS. 3 and 4. Furthermore, a tilted angle of the driving post 52 is changed by using the adjustment screw 6 and the push portion 522, thus changing the clamping distance between the fixed clamp jaw 1 and the movable clamp jaw 2 and a distance between the first handle 3 and the second handle 4, as illustrated in FIGS. 5 and 6.

In addition, the fixed clamp jaw 1 has first engaging teeth 11 and a first cutting blade 12 which are arranged on the inner surface of the fixed clamp jaw 1, the movable clamp jaw 2 has second engaging teeth 21 and a second cutting blade 22 which are formed on the inner surface of the movable clamp jaw 2, such that the workpiece is clamped or is cut by the fixed clamp jaw 1 and the movable clamp jaw 2.

Accordingly, the fixed clamp jaw 1 and the movable clamp jaw 2 are fixed by way of the adjustment screw 6 so that they clamp the workpiece firmly. Preferably, the tilted angle of the driving post 52 is changed by using the adjustment screw 6 and the push portion 522 so as to adjust the clamping distance between the fixed clamp jaw 1 and the movable clamp jaw 2 and the distance between the first handle 3 and the second handle 4 based on using requirements.

While the preferred embodiments of the invention have been set fourth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. A safety structure for pliers comprising: a fixed clamp jaw, a movable clamp jaw, a first handle, a second handle, an actuation unit, and an adjustment screw; wherein
the fixed clamp jaw is disposed on one end of the first handle, one end of an inner surface of the movable clamp jaw is rotatably connected with an inner surface of the fixed clamp jaw, and one end of an outer surface of the movable clamp jaw is rotatably coupled with the second handle, between the first handle and the second handle is defined a hollow space, the actuation unit includes a spring, a driving post, a threaded post, and a pushing post, wherein a first end of the spring is mounted on an inner surface of the first handle, and a second end of the spring is fixed between two rotatable connecting portions of the movable clamp jaw, a first end of the driving post is rotatably connected with an inner surface of the second handle, and a second end of the driving post is inserted into the inner surface of the first handle, the driving post has an arcuate section formed on an outer surface thereof and is locked on an edge of the first handle, and an edge of the threaded post abuts against the second end of the driving post, the pushing post is rotatably joined with the inner surface of the second handle and its one end corresponds to and is forced by the arcuate section, the driving post has a push portion formed on the first end thereof, and the adjustment screw is screwed into an outer surface of the second handle and its first end abuts against the push portion.

2. The safety structure for the pliers as claimed in claim 1, wherein the fixed clamp jaw has first engaging teeth and a first cutting blade which are arranged on the inner surface of the fixed clamp jaw, the movable clamp jaw has second engaging teeth and a second cutting blade which are formed on the inner surface of the movable clamp jaw.
